(19) United States
(12) Patent Application Publication
(10) Pub. No.: US 2009/0181558 A1
(43) Pub. Date: Jul. 16, 2009

(54) CONNECTION FOR A DUAL-DENSITY PRINTED CIRCUIT BOARD

(75) Inventor: Chad W. Morgan, Mechanicsburg, PA (US)

Correspondence Address: Tyco Technology Resources, 4450 New Linden Hill Road, Suite 140, Wilmington, DE, 19808, US

(73) Assignee: Tyco Electronics Corporation, Middletown, PA (US)

(21) Appl. No.: 11/972,276

(22) Filed: Jan. 10, 2008

(51) Int. Cl. H01R 12/00

(52) U.S. Cl. 439/66; 29/829

(57) ABSTRACT

A connector for connecting conductors to a dual-density printed circuit board (PCB) having opposite first and second major surfaces and a method of manufacturing the same. In one embodiment, a connector includes a (1) first dielectric connector frame having a plurality of contacts connected to conductors, the plurality of contacts couplable to a corresponding plurality of conductive via contacts on the first major surface of the dual-density PCB, and (2) a second dielectric connector frame having a plurality of contacts connected to conductors, the plurality of contacts couplable to a corresponding plurality of conductive via contacts on the second major surface of the dual-density PCB.

### TECHNICAL FIELD

The invention is directed, in general, to a connector for a printed circuit board (PCB) and, more specifically, to a connector for a dual-density PCB.

### BACKGROUND

As electronic devices become smaller and include more functions, the allocation of connection space becomes an issue. Because only so much space is available on a regular PCB for electrical connections, alternative solutions for connecting various electronic components must be found. The inherent structure of a conventional PCB also has certain characteristics that limit the number of connections available and make it even more difficult to decrease device scale while adding to device functionality. Due to this inherent structure limitation it is not possible to meaningfully increase the number of connections on a standard PCB board by decreasing the size of the conductive through-hole connection vias. This is because via size is limited by its aspect ratio; which is the ratio the PCB thickness to the diameter of the via. A via having an aspect ratio of ten to one is about as extreme as can be made and still be commercially viable.

One solution to the problem of limited space on a PCB is to use a dual-density PCB. Dual-density PCBs are known and can substantially increase the number of available connections that can be made to a PCB. A dual-density PCB is constructed by laminating a thin dielectric substrate with predrilled conductive vias to each side of an insulating dielectric layer with the conductive vias on one side about opposite the vias on the other side. Because the vias are not in electrical contact with each other they can be used independently of each other in a circuit design. A dual-density PCB is basically a sandwich of dielectric substrates with an insulating dielectric layer in the middle separating substrates having predrilled vias on each side. Because of the thinness of the dielectrics with the predrilled vias, vias can be made much smaller, shorter and with shorter length stubs. In most cases a dual-density PCB, after it is assembled, will also have a regular via drilled through the entire PCB to be used as a common electrical ground.

Although offering substantial technological benefits, dual-density PCBs have not been widely used because of the expense of fabrication when compared to regular PCBs. However, as transfer rates and data speeds increase, the use of dual-density PCBs will also most likely increase because the electronics industry will need them in order to supply electronic devices meeting customer requirements. As the use of dual-density PCBs increases, one useful application will be in electronic devices such as mother-boards and daughter-cards. What is needed in the art is a connector that will permit connections to each side of a dual-density PCB, particularly when the dual-density PCB serves as a daughter-card. Other issues that need to be addressed in the use of dual-density PCBs are footprint signal integrity problems arising out of the increased number of contact points where the PCB meets a connector.

Accordingly, what is needed in the art is a high density connector for connecting to both sides of a dual-density PCB.

### SUMMARY

To address the above-discussed deficiencies of the prior art, one aspect of the invention provides a connector for a dual-density PCB having opposite first and second major surfaces. In one embodiment, the connector includes: (1) a first dielectric connector frame having a plurality of contacts connected to conductors, the plurality of contacts couplable to a corresponding plurality of conductive via contacts on the first major surface of the dual-density PCB and (2) a second dielectric connector frame having a plurality of contacts connected to conductors, the plurality of contacts couplable to a corresponding plurality of conductive via contacts on the second major surface of the dual-density PCB.

A connection system is also described for coupling a dual-density PCB having opposite first and second major surfaces to a backplane. A method of manufacturing a connector for use with a dual-density PCB having opposite first and second major surfaces is also described.

The foregoing has outlined certain aspects and embodiments of the invention so that those skilled in the art may better understand the detailed description of the invention that follows. Additional embodiments will be described hereinafter that form the subject of the claims of the invention. Those skilled in the art should appreciate that they can readily use the disclosed aspects and embodiments as a basis for designing or modifying equivalent structures for carrying out the same purposes of the invention. Those skilled in the art should also realize that such equivalent constructions do not depart from the scope of the invention.

### BRIEF DESCRIPTION OF THE DRAWINGS

For a more complete understanding of the invention, reference is now made to the following descriptions taken in conjunction with the accompanying drawings, in which:

FIG. 1 illustrates a planar side view of a prior art dual-density PCB;

FIG. 2 illustrates an isometric view of a connector constructed in accordance with the invention for use with a dual-density PCB having opposite major first and second surfaces;

FIG. 3 illustrates a cross sectional view of conductors in a dielectric connector constructed in accordance with the invention as they are connected to conductive via contacts in a dual density PCB;

FIG. 4 illustrates an embodiment of a system constructed in accordance with the invention for utilizing dual density PCBs as daughter-cards and mounting them in a co-planar architecture on opposite sides of a backplane;

FIG. 5 illustrates an embodiment of the invention where a backplane has a connector mounted on each major surface such that the dual density PCBs coupled thereto are each orthogonal to the backplane as well as with respect to each other;

FIG. 6 illustrates an embodiment of the invention with a dual-density PCB permanently mounted to a connector constructed in accordance with the invention;

FIGS. 7A and 7B illustrate a cross sectional views of a dual density PCB mounted to a connector in accordance with one embodiment of the invention; and

FIG. 8 illustrates a flow chart of one embodiment of a method of manufacture in accordance with the invention of a connector for use with a dual-density PCB.

### DETAILED DESCRIPTION

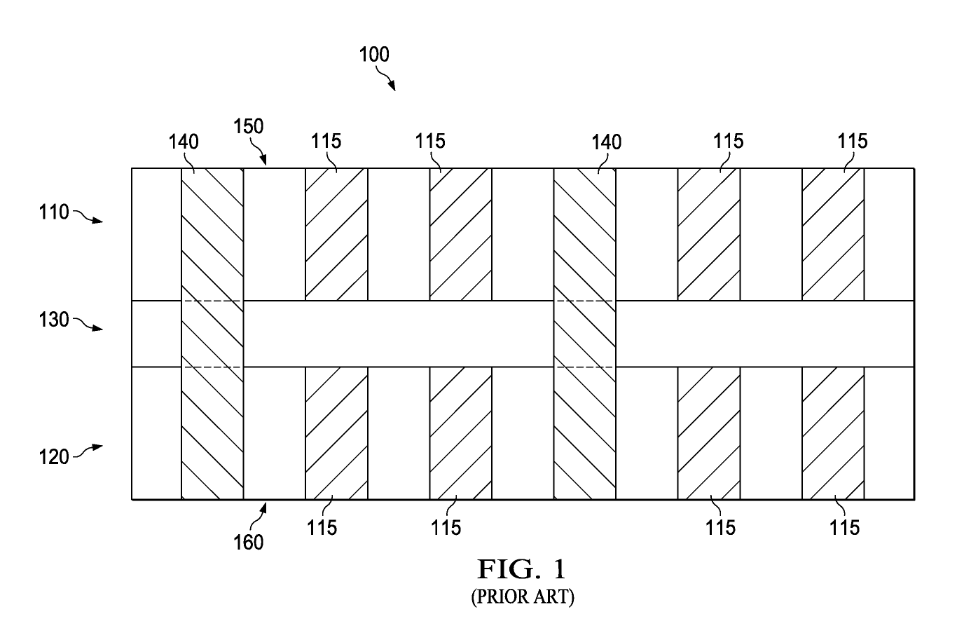

Referring initially to FIG. 1, illustrated is a planar side view of a prior art dual-density PCB 100. The dual-density PCB 100 is made up of a number of layers of dielectric material laminated together. Before being laminated, a first dielectric layer 110 is formed with a number of vias that, when plated, will be a plurality of conductive via contacts 115. The first dielectric layer 110 is then laminated to an insulating dielectric layer 130. A second dielectric layer 120 with a number of vias that, when plated, will also be a plurality of conductive via contacts 115, is also formed and laminated to the opposite side of the insulating dielectric layer 130. As illustrated, conductive via contacts 115 in the first dielectric layer 110 are located approximately opposite conductive via contacts 115 in the second dielectric layer 120. However, because of the intervening insulating dielectric layer 130, the conductive via contacts 115 in the first dielectric layer 110 are not in electrical contact with the conductive via contacts 115 in the second dielectric layer 120. After lamination of the dual-density PCB 100, any through contact vias 140 deemed necessary are drilled through the entire assembled dual-density PCB 100. These through contact vias 140 can be usefully employed for grounding purposes as well as for additional circuitry. The illustrated dual-density PCB 100 has opposite major first 150 and second 160 surfaces.

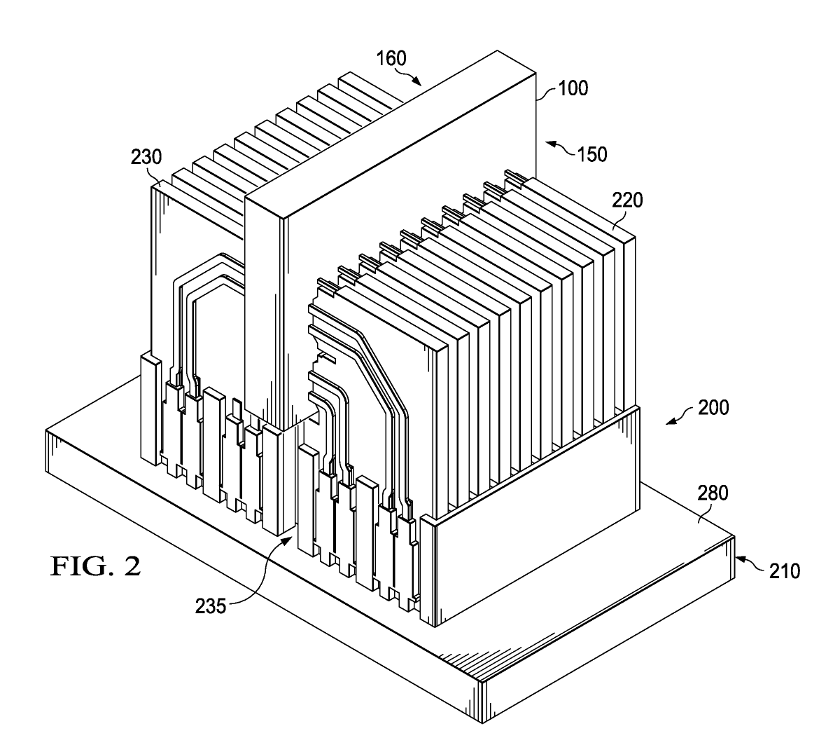

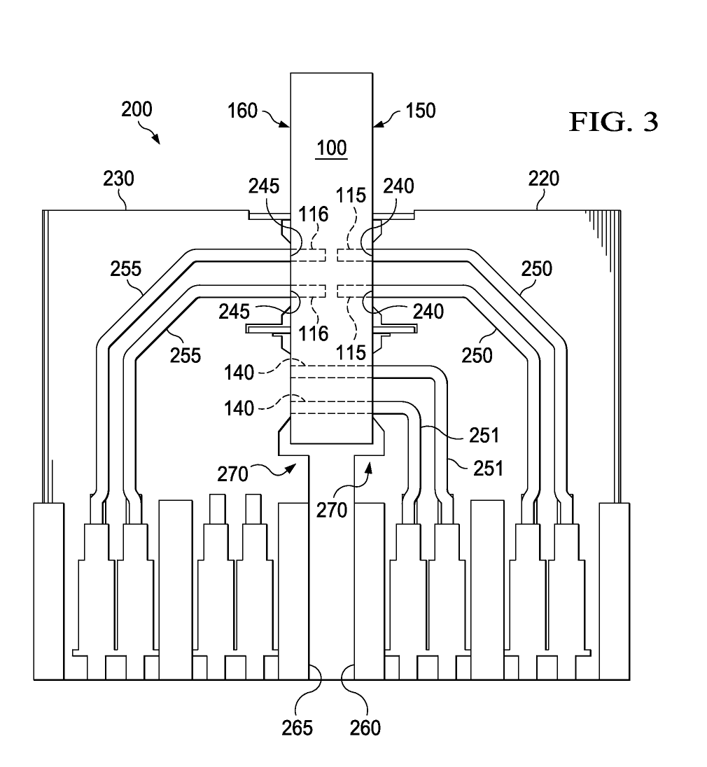

Turning now to FIG. 2, illustrated is an isometric view of a connector 200 constructed in accordance with the principles of the invention for use with a dual-density PCB 100 having opposite major first 150 and second 160 surfaces. The illustrated connector 200 will be explained in conjunction with FIG. 3, which is a planar cross sectional view of the connector 200 constructed in accordance with the principles of the invention connected to a dual-density PCB 100. The connector 200 is mounted on a backplane 210. In FIG. 2, the connector 200 is a two piece connector with a first dielectric frame 220 and a second dielectric frame 230. Of course the connector 200 can also be a single piece connector. FIG. 3 illustrates the connector 200 having a plurality of contacts 240 connected to a plurality of conductors 250 in the first dielectric frame 220. The conductors 250 may connect various electronic components in an electronic device. This plurality of contacts 240 are arranged to be couplable to a corresponding plurality of conductive via contacts 115 on the first major surface 150 of the dual density PCB 100. Opposite the first dielectric frame 220 is the second dielectric frame 230 with a plurality of contacts 245 connected to a plurality of conductors 255. The plurality of contacts 245 in the second dielectric frame 230 are arranged to be couplable to a corresponding plurality of conductive via contacts 116 on the second major surface 160 of the dual density PCB 100. The conductors 255 in the second dielectric frame 230 also form part of an electrical circuit, but not necessarily the same electrical circuit as the conductors 250 in the first dielectric frame 220 because the conductors 250 in the first dielectric frame 220 are electrically isolated from the conductors 255 in the second dielectric frame 230. Because a dual-density PCB 100 may have smaller via contacts 115, 116 than a regular PCB, dual-density PCBs 100 permit a much faster operating speed than regular PCBs, which are basically limited in speed by the aspect ratio of the PCB vias themselves. It is readily apparent that a connector 200 constructed in accordance with the principles of the invention will be a high-density connector 200 in order to mate with the dual-density PCB 100.

The first dielectric frame 220 and second dielectric frame 230 can also be constructed to form a high density clamshell type of connector 200. The illustrated dual-density PCB 100 is a daughter-card that, when combined with the connector 200, may, in some embodiments, conserve space as well as yield other benefits. These other benefits may include a reduction in length of the connector 200 transmission lines and, because of the improved aspect ratios of the smaller vias, perhaps a reduction of daughter-card stub capacitance and footprint noise where the daughter-card meets the connector 200.

FIG. 3 illustrates conductors 251 in the first dielectric frame 220 connected to conductive through-via contacts 140 in the dual density PCB 100. Such through-via contacts 140 may be used for grounding purposes or with other circuitry as ordinary via contacts 140. Also illustrated is a beneficial feature of the connector 200 in that it is constructed with minimal overhang 270 so that the first dielectric frame 220 edge 260 and the second dielectric frame 230 edge 265 do not interfere with each other when used with a dual density PCB 100. This is an important feature when a connector 200 is designed for use with a PCB 100 having dual-density vias.

Certain embodiments of the invention can be usefully employed as part of a system for coupling dual density PCBs 100 into an electronic circuit. A particularly useful embodiment provides for dual density PCBs 100 to be used as daughter-cards in backplane architecture arrangements. In a standard backplane architecture, daughter-cards are inserted much like books on a bookshelf. A connector, such as that illustrated in FIG. 2, can be usefully employed in such an architecture by having a connector 200, or connectors 200, coupled to a major surface 280 of a backplane 210. A dual-density PCB 100 daughter-card is permanently mounted to the first dielectric frame 220 and the second dielectric frame 230. That assembly is then plugged into a receptacle 235 portion of the connector 200 so that the assembly's major surfaces 150, 160 are orthogonal to the major surface of the backplane 210. This system can be expanded to a series of connectors 200 mounted to the backplane 210, each of which receives a dual density PCB 100 daughter-card. As hereinafter noted, the dual-density PCB 100 daughter-card can be removably plugged into the connector 200 or it can be permanently mounted therein. The use of a dual-density PCB 100 as a daughter-card resolves daughter-card footprint problems, but does nothing to resolve backplane 210 footprint problems where the connector connects to circuitry in the backplane.

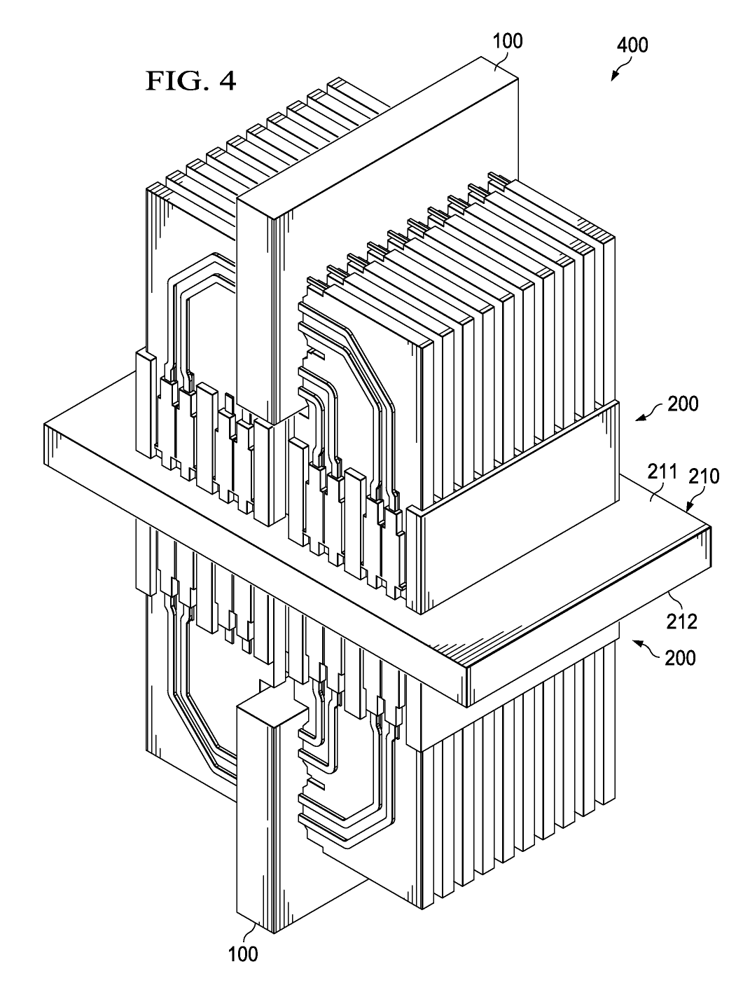

Turning now to FIG. 4, illustrated is an embodiment of a system 400 constructed in accordance with the principles of the invention for utilizing dual density PCBs 100 as daughter-cards and mounting them in planar fashion on opposite sides of a backplane 210. This is illustrative of a mid-plane, or co-planar, architecture where connectors 200 are coupled to both major surfaces 211, 212 of the backplane 210. The connectors 200 are mounted so the dual density PCBs 100 can be plugged into each side orthogonal to the backplane 210 but parallel to each other. Again, a number of connectors 200 on each major surface 211, 212 of the backplane can be deployed and be within the scope of the invention. As was the case with the standard backplane 210 architecture, footprint problems arising out of the backplane 210 junction with the connector remain an issue. In one embodiment, the backplane 210 is also a dual-density PCB 100.

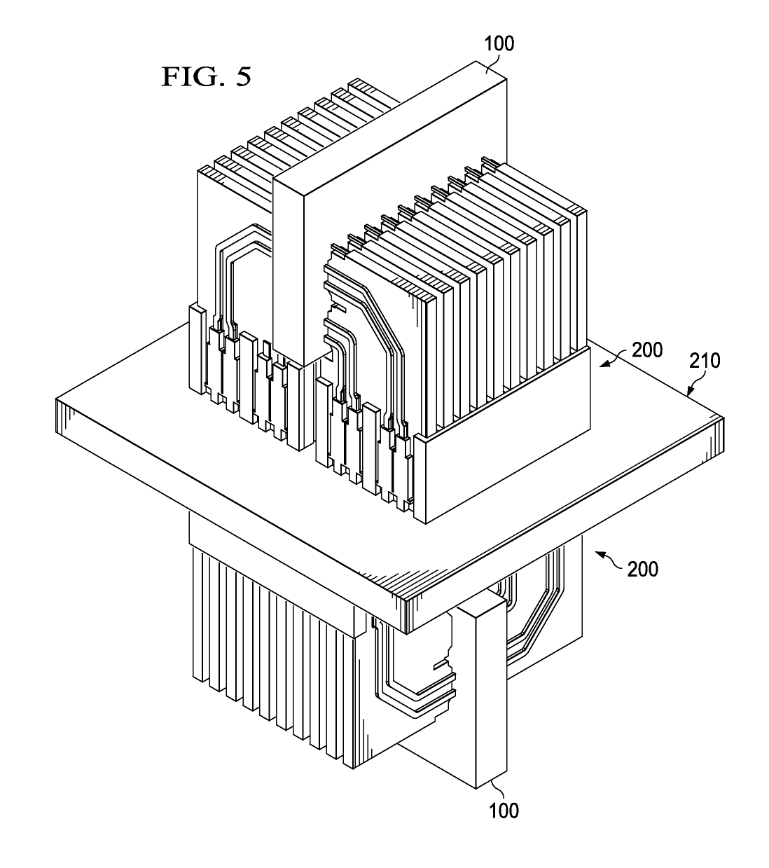

Turning now to FIG. 5, illustrated is another embodiment of the invention where a backplane 210 has a connector 200 mounted on each major surface such that the dual density PCBs 100 coupled thereto are each orthogonal to the backplane 210 as well as with respect to each other. This is illustrative of a cross-connect or orthogonal type of architecture. In this architecture the dual-density PCB 100 daughter-cards are inserted into a connector 200 on each side of the backplane 210 perpendicular to each other.

FIG. 5 can also be used to illustrate a mid-planeless or orthogonal architecture where the midplane, or backplane 210, is used solely for alignment or power distribution purposes. Because it does not contain active circuitry, as does the backplane 210 in the other architectures, there are fewer footprint signal integrity issues where the connector meets the backplane. In still another embodiment of such an orthogonal architecture no midplane exists. Instead, the dual-density PCBs 100 are mounted orthogonal relative to each other by utilizing an apparatus that supports and connects connectors 200 to each other. In this architecture, the footprint problem arising out of the backplane 210 is resolved because there is no midplane.

Any configuration of connectors 200 for a dual-density PCB 100 is intended to be within the scope of the invention. For example, two or more connectors 200 coupled to the same side of a backplane 210, with a dual-density PCB 100 in each connector 200 and mounted parallel to each other would be within the scope of the invention. The dual-density PCBs may even be at an angle to each other on the same side of a backplane 210 (including being orthogonal) and be within the scope of the invention. By the same token, a series of backplanes 210 with connectors 200 coupled thereto can be used in a system architecture and be within the scope of the invention, regardless of the arrangement. For example, a series of backplanes 210 having connectors 200 coupled thereto can be stacked vertically or be placed or mounted in parallel bookshelf form or even at an angle to each other and be within the scope of the invention. As noted, in one embodiment, the backplane 210 serves no function other than to support the connectors 200. In still another embodiment, there is no backplane 210 support because the connectors 200 are arranged to either support each other or are mounted on a special support relative to each other, all of which embodiments are within the scope of the invention.

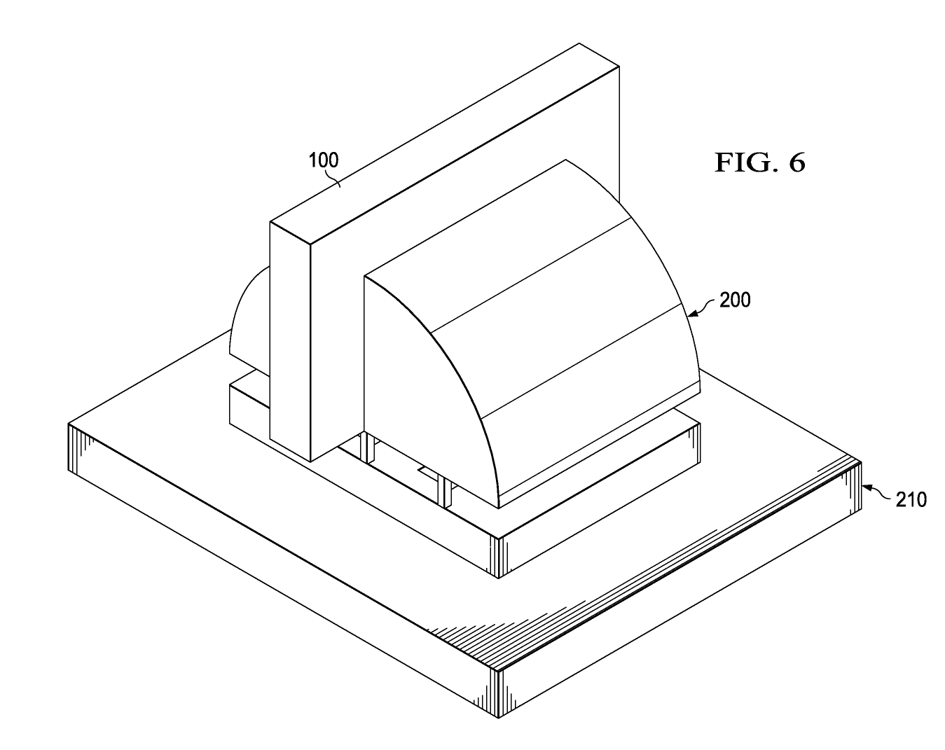

Turning now to FIG. 6, illustrated is an embodiment where a dual-density PCB 100 is permanently mounted to a connector 200 constructed in accordance with the invention. The illustrated embodiment may have the dual-density PCB 100 permanently coupled to the connector 200 or the connector 200 may be permanently coupled to a backplane 210 with the dual density PCB 100 removably mounted.

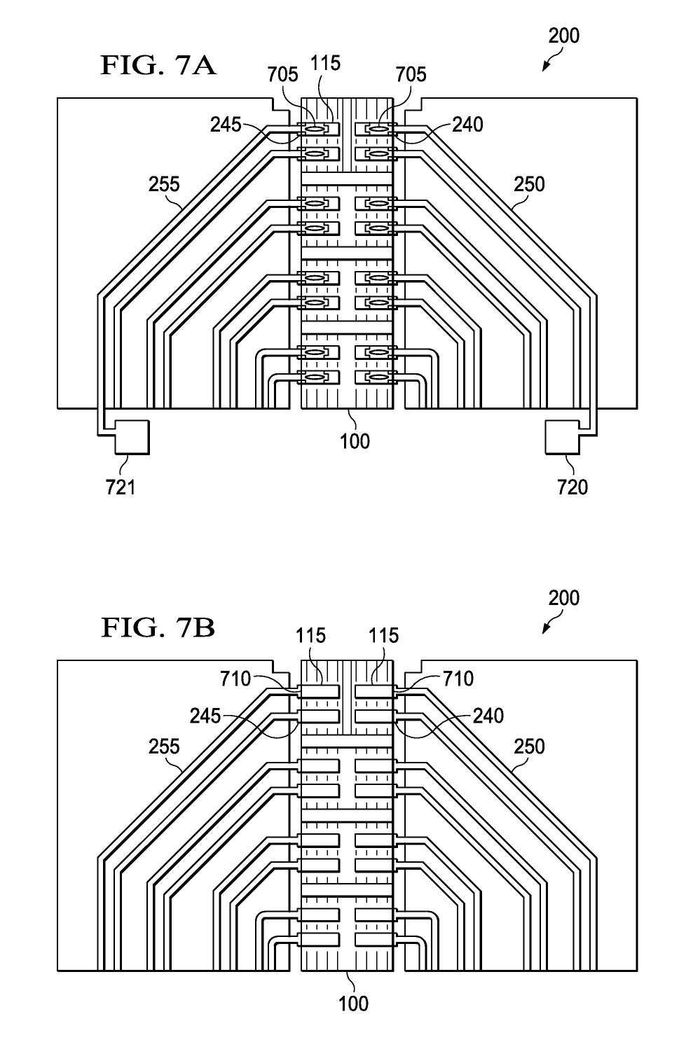

Turning now to FIGS. 7A and 7B, illustrated are cross sectional views of a dual-density PCB 100 mounted in a connector 200 in accordance with one embodiment of the invention. If the dual-density PCB 100 is to be permanently mounted in the connector 200, one embodiment provides for the contacts 240, 245 to be soldered to the via contacts 115. In another embodiment, the conductors 250, 255 terminate in contacts 240, 245 that are pressfit pins 705 that plug into via contacts 115 and permanently couple the connector 200 to the dual-density PCB 100. Also illustrated in FIG. 7A, are representations of a plurality of electronic components 720, 721 that are electrically connected through the conductors 250, 255.

In still another embodiment, illustrated in FIG. 7B, the conductors 250, 255 terminate in surface mount contacts 710 that are soldered to corresponding contact pads on the surface of the PCB 100. These contact pads can be metalized annular rings on the surface of the PCB 100, each of the rings surrounding and electrically connected to one of the contact vias 115. Regardless of how the dual-density PCB 100 is coupled to a connector 200, such connection falls within the scope of the invention. For example, either the contacts 240, 245 or the via contacts 115 could be spring actuated and be within the scope of the invention. The connector 200 could be constructed so that the first dielectric frame 220 is hinged to the second dielectric frame 230 and closes about the dual-density PCB 100 in clamshell fashion to lock it into position, which embodiment is within the scope of the invention.

In one embodiment, a plurality of components are connected electrically through the illustrated connectors 200 and the dual density PCBs 100. In another embodiment, the plurality of components constitute an electronic device.

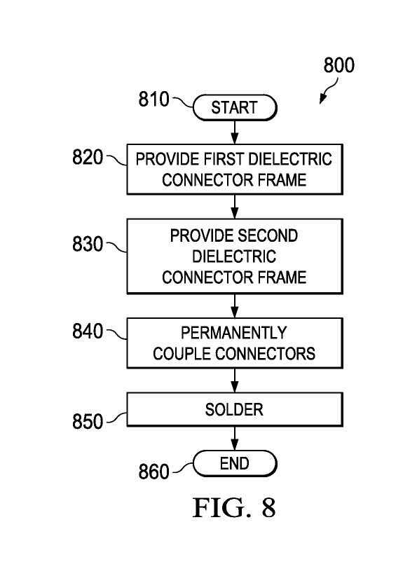

Turning now to FIG. 8, illustrated is a flow chart of one embodiment of a method of manufacturing 800 a connector in accordance with the principles of the invention for use with a dual-density PCB. The method commences with a start step 810. In a provide first dielectric connector frame step 820, a first dielectric connector frame is provided, which first dielectric connector frame has a plurality of contacts connected to conductors couplable to a corresponding plurality of conductive via contacts on a first major surface of a dual-density PCB. In a provide second dielectric connector frame step 830, a second dielectric connector frame is provided with a plurality of contacts connected to conductors that are couplable to a corresponding plurality of conductive via contacts on a second major surface of a dual-density PCB. In a permanently couple connectors step 840, the connectors are permanently coupled to a dual-density PCB. In a solder step 850, the plurality of contacts are soldered to conductive via contacts on the first and second major surfaces of the dual density PCB The method concludes with an end step 860.

Although certain aspects and embodiments of the invention have been described in detail, those skilled in the art should understand that they can make various changes, substitutions and alterations herein without departing from the scope of the invention in its broadest form.

1. A connector for use with a dual-density printed circuit board (PCB) having opposite first and second major surfaces, comprising:
a first dielectric connector frame having a plurality of first contacts connected to conductors, said plurality of first contacts couplable to a corresponding plurality of conductive via contacts on said first major surface of said dual-density PCB; and
a second dielectric connector frame, separate from said first dielectric connector frame, having a plurality of second contacts connected to conductors, said plurality of second contacts couplable to a corresponding plurality of conductive via contacts on said second major surface of said dual-density PCB.

2. The connector as recited in claim 1 wherein said connector is permanently coupled to said dual-density PCB.

3. The connector as recited in claim 2 wherein said plurality of first and second contacts are soldered to said conductive via contacts on said first and second major surfaces.

4. The connector as recited in claim 2 wherein pressfit pins are used to couple said plurality of contacts to said conductive via contacts on said first and second major surfaces.

5. The connector as recited in claim 2 wherein surface mount contacts are used to couple said plurality of contacts to said conductive via contacts on said first and second major surfaces.

6. The connector as recited in claim 1 wherein said dual-density PCB is removably plugged into said first dielectric connector frame and said second dielectric frame.

7. The connector as recited in claim 6 wherein said first dielectric connector frame and said second dielectric connector frame are constructed to form a clamshell type connector.

8. The connector as recited in claim 1 further comprising a plurality of electronic components connected electrically through said connector.

9. The connector as recited in claim 8 wherein said plurality of electronic components constitute an electronic device.

10. The connector as recited in claim 1 wherein said first dielectric connector and said second dielectric connector have minimal overhang over an edge of said dual density PCB.

11. A system for coupling a dual-density printed circuit board (PCB) to a circuit, comprising:
a backplane having opposite first and second major surfaces;
a first connector coupled to said first major surface of said backplane; and
a first dual-density PCB having opposite first and second major surfaces coupled to said first connector, said first connector including:
a first dielectric connector frame having a plurality of first contacts connected to conductors, said plurality of first contacts couplable to a corresponding plurality of conductive via contacts on said first major surface of said first dual-density PCB, and
a second dielectric connector frame, separate from said first dielectric connector frame, having a plurality of second contacts connected to conductors, said plurality of second contacts couplable to a corresponding plurality of conductive via contacts on said second major surface of said first dual-density PCB.

12. The system as recited in claim 11 wherein said dual-density PCB is orthogonal to said backplane.

13. The system as recited in claim 11 further comprising a second connector coupled to said second major surface of said backplane , said second connector couplable to a second dual density PCB.

14. The system as recited in claim 13 wherein said second dual density PCB is orthogonal to said backplane and to said first dual-density PCB.

15. The system as recited in claim 11 wherein said backplane is a dual density PCB.

16. The system as recited in claim 14 wherein said backplane serves solely as a support structure for said connection system.

17. A method of manufacturing a connector for use with a dual-density printed circuit board (PCB) having opposite first and second major surfaces, comprising:
providing a first dielectric connector frame having a plurality of contacts connected to conductors, said plurality of contacts couplable to a corresponding plurality of conductive via contacts on the first major surface of said dual-density PCB; and
providing a second dielectric connector frame, separate from said first dielectric connector frame, having a plurality of contacts connected to conductors, said plurality of contacts couplable to a corresponding plurality of conductive via contacts on the second major surface of said dual-density PCB.

18. The method of manufacturing as recited in claim 17 wherein said connector is permanently coupled to said dual-density PCB.

19. The method of manufacturing as recited in claim 18 wherein said plurality of contacts are soldered to said conductive via contacts on said first and second major surfaces.

20. The method of manufacturing as recited in claim 18 wherein pressfit pins are used to couple said plurality of contacts to said conductive via contacts on said first and second major surfaces.
